(19) United States
(12) Patent Application Publication
(10) Pub. No.: US 2006/0268080 A1
(43) Pub. Date: Nov. 30, 2006

(54) Ink cartridge and ink-jet recording device

(75) Inventor: Yusuke Nakazawa, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/437,817

(22) Filed: May 22, 2006

(30) Foreign Application Priority Data
May 24, 2005 (JP) P. 2005-151328

(51) Int. Cl. B41J 2/175

(52) U.S. Cl. 347/86

(57) ABSTRACT

An ink recording device includes: an ink cartridge storing an ink curable by irradiation with an actinic energy ray, the ink cartridge having an ink stirring member inside thereof; and an drive section disposed lateral to the ink cartridge and in a position facing to the stirring member at a time installing the ink cartridge on the installing section.

### BACKGROUND OF THE INVENTION

1. Field of the Invention

The present invention relates to an ink cartridge for storing an ink which is curable by actinic energy ray such as electron beams and ultraviolet rays, and to an ink-jet recording device for feeding an ink using this cartridge, and forming an image on a recording medium by ink-jetting.

2. Background Art

There has been proposed an ink-jet recording device for feeding by cartridge an ink which is curable by actinic energy ray such as electron beams and ultraviolet rays, discharging the ink onto a recording medium using an ink-jet head and curing the ink by irradiation with energy to form an image. This ink-jet recording device has, as properties of the ink itself, features that it can meet requirements such as realization of high-speed recording on various recording media, formation of a high-definition image which hardly causes oozing, and less influence against the environment. In particular, the development of devices using an ink which is curable by ultraviolet rays as the active energy is advancing from the viewpoints of easiness of handling of a light source and compactification.

In such an ink-jet recording device, the classification of coloring materials of the ink is classified into a dye system and a pigment system. In the dye system, in general, the viscosity of coloring materials is low. So, because the coloring materials are dissolved, the ink is homogenized, the color saturation is high, and the handling is easy. Accordingly, utilization of the dye system has advanced. However, in recent years, inks of a pigment system get attention from the viewpoint of weather resistance or the like. In particular, it is vigorous to develop white inks and special color inks such as inks of a metallic gloss described in JP-A-2004-181643 (the term “JP-A” as used herein means an “unexamined published Japanese patent application”) and JP-A-2004-090487.

In the case of white inks or special color inks such as inks of a metallic gloss, these inks are in general a dispersion type ink in which particles of coloring material components are heavy and liable to cause sedimentation. In particular, if the ink is such a dispersion type ink, in the case where an ink-jet recording device is not operated for a long time, there is some possibility that the precipitation within an ink cartridge which is installed within the ink-jet recording device is exposed, resulting in causing poor discharge. In response thereto, there is not taken a special construction as the device.

### SUMMARY OF THE INVENTION

In view of the aforementioned problems, the invention has been made. An object of the invention is to provide an ink cartridge for actinic energy ray-curable type, the ink cartridge capable of controlling internal precipitation of an ink. Another object of the invention is to provide an ink-jet recording device which is able to control the generation of poor discharge by utilizing such the ink cartridge and to warm-up rapidly even after stopping the ink recording device for a long time, and which is excellent in stability and running costs.

The aforementioned objects of the invention have been attained by the following constructions.

(1) An ink cartridge storing an ink curable by irradiation with an actinic energy ray, wherein the ink cartridge has a stirring member inside thereof.

(2) The ink cartridge as set forth above in the item (1), wherein the stirring member is a magnetic rotor.

(3) An ink-jet recording device forming an image on a recording medium by jetting an ink, the ink being curable by irradiation with an actinic energy ray, which comprises:

a recording section having an ink-jet head discharging the ink onto the recording medium;

an ink cartridge having a stirring member inside thereof;

a cartridge installing section being freely detachable to the ink cartridge and feeding the ink into the ink-jet head at a time installing the ink cartridge on the cartridge installing section; and

a drive section disposed lateral to the ink cartridge and in a position facing to the stirring member at a time installing the ink cartridge on the cartridge installing section, the drive section being able to activate the stirring member at a timing.

As described previously, by providing the stirring member within the ink cartridge, providing the drive section at the position of the ink-jet recording device for actinic energy ray-curable type ink at which the ink cartridge is installed and properly this stirring member, the precipitation of an ink within the ink cartridge can be controlled, and the generation of poor discharge of ink-jetting can be suppressed.

(4) The ink-jet recording device as set forth above in the item (3), wherein the stirring member is a magnetic rotor, and the drive section comprises a rotary magnet section capable of giving a torque to the magnetic rotor from the outside of the ink cartridge.

By using a magnetic rotor as the stirring member and applying the drive section as a rotary magnet section to this rotor, it is possible to carry out stirring of the ink within the ink cartridge without applying special processing to a casing of the ink cartridge.

(5) The ink-jet recording device as set forth above in the item (3) or (4), wherein the timing activating the stirring member is a time turning on the power-supply into the ink-jet recording device.

(6) The ink-jet recording device as set forth above in the items (3) to (5), wherein the timing activating the stirring member is a time installing the ink cartridge.

(7) The ink-jet recording device as set forth above in the items (3) to (6), wherein the timing activating the stirring member is a time after a lapse of a downtime of the image formation such a degree that precipitation inside of the irk cartridge is actualized.

As set forth above in the items (5), (6) and (7), the timing activating the stirring member is the time turning on the power-supply into the ink-jet recording device for the actinic energy ray-curable type ink, the time installing the ink cartridge, or after a lapse of a downtime of the image formation such a degree that precipitation inside of the ink cartridge is actualized.

According to the invention, by providing an ink cartridge having a stirring member inside thereof, internal precipitation of the ink can be controlled. In addition, by ink-jet recording device for an actinic energy ray-curable type ink utilizing such the ink cartridge, it is possible to control the generation of poor discharge, to achieve rapid warm-up even after stopping the device over a long period of time and to provide recording which is excellent in stability and running costs.

### BRIEF DESCRIPTION OF THE DRAWINGS

The invention disclosed herein will be understood better with reference to the following drawings of which:

FIG. 1 is a schematic view illustrated construction of an ink-jet recording device for an actinic energy ray-curable type according to an embodiment of the invention;

FIG. 2 is a partial perspective oblique view of an enlarged cartridge installing section;

FIG. 3 is a partial schematic view illustrated other construction of an image recording section;

FIG. 4 is a partial schematic view illustrated a still other construction of an image recording section; and

FIG. 5 is a schematic view illustrated construction of an ink-jet recording device for an actinic energy ray-curable type according to another embodiment of the invention.

### DETAILED DESCRIPTION OF THE INVENTION

Exemplary embodiments of the invention will be hereunder described with reference to the accompanying drawings. However, it is to be understood that the invention is not intended to be limited to the specific embodiments.

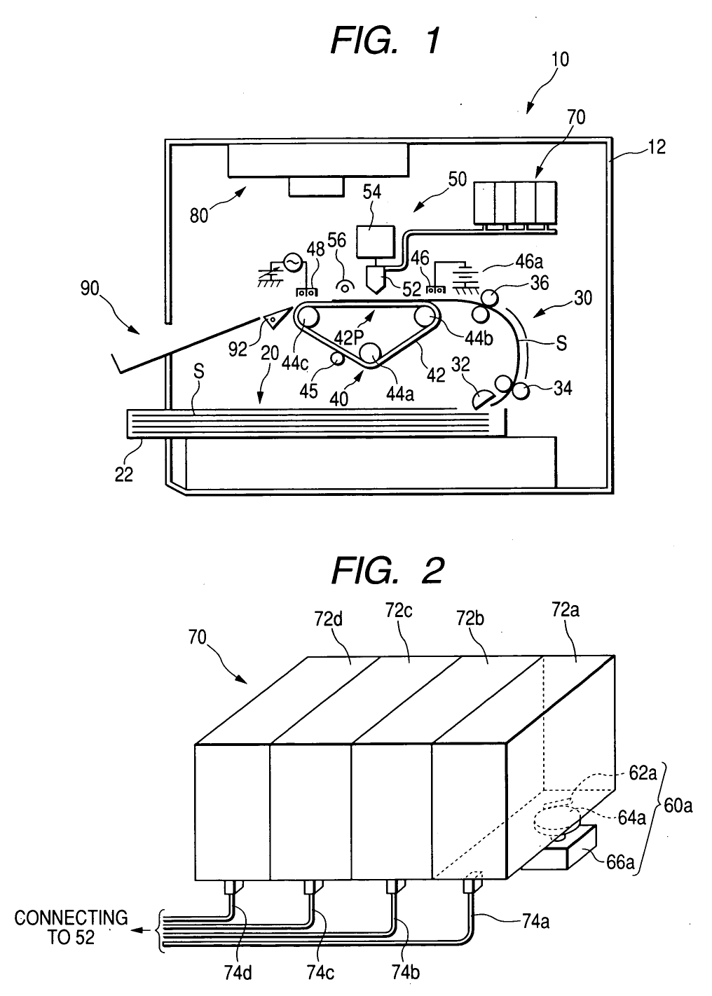

FIG. 1 is a schematic view illustrated a construction of an ink-jet recording device for an actinic energy ray-curable type ink according to an embodiment of the invention.

In FIG. 1, in a casing 12 of ink-jet recording device 10 for an actinic energy ray-curable type ink, there are provided a recording medium accommodating section 20 for accommodating plural sheets of a sheet-like recording medium S of the same size as piled up; a traveling section 30 for taking out the recording medium S from this accommodating section 20; a scanning and traveling section 40 for achieving scanning while keeping the recording medium S as traveled thereinto by the traveling section 30 within the recording position range; a recording section (hereinafter also referred to as an “image recording section”) 50 for subjecting the recording medium S which is kept, traveled and scanned in the scanning and traveling section 40 to ink-jet image recording, irradiation with actinic energy ray (ultraviolet rays in this embodiment) and fixation; and a tray 90 in which the recording medium S which has been recorded in the image recording section 50 is sent out. In the image recording section 50, a cartridge installing section 70 is connected for the purpose of feeding an ink. In this cartridge installing section 70, an ink cartridge (hereinafter also simply referred to as a “cartridge”) as described later is provided in a freely detachable manner.

In the recording medium accommodating section 20, an accommodating cassette 22 for accommodating the recording medium S is disposed in a freely detachable manner in a lower part of the casing 12 of the ink-jet recording device 10 for the actinic energy ray-curable type ink, and by exchanging the cassette, it is possible to feed a seconding medium S having a different size. This recording medium accommodating section 20 can also be constructed so as to accommodate plural cassettes therein. The traveling section 30 is provided with a feed roll 32 coming into contact with the tip of an insertion direction of the recording medium S within the accommodating cassette 22 as set in the casing 12. In addition, the traveling section 30 is provided with traveling roll pairs 34, 36 for traveling the recording medium S as drawn out by the feed roll 32 into the scanning and traveling section 40.

The scanning and traveling section 40 is provided with a traveling belt 42 which is tensioned and driven by three belt rolls 44a, 44b and 44c. The traveling belt 42 is driven in a direction from the upstream belt roll 44b to the downstream belt roll 44c; and the recording medium S is placed and traveled on the traveling belt 42 between the upstream belt roll 44b and the downstream belt roll 44c. At the position with which the tip of the recording medium S as traveled from the traveling roll pair 36 of the traveling section 30 first comes into contact (the position of the upstream belt roll 44b in this embodiment), a corona charger 46 is provided for the purpose of bringing the traveling belt 42 and the recording medium S into intimate contact with each other and disposed to a degree that it does not come into contact with the recording medium S on the traveling belt 42 and in close vicinity to the traveling belt 42. In addition, at the position at which the recording medium S is separated from the traveling belt 42 (the position of the downstream belt roll 44c in this embodiment), a static eliminator 48 is provided and disposed to a degree that it does not come into contact with the recording medium S on the traveling belt 42 and in close vicinity to the traveling belt 42. Furthermore, a substantially middle position between the upstream belt roll 44b and the downstream belt roll 44c is defined as an image recording position 42P.

In the image recording section 50, a head unit 52 to which the cartridge installing section 70 is connected for the purpose of feeding an ink is provided in such a manner that the tip of an ink injecting section thereof is located towards the traveling belt 42 at the image recording position 42P. A head driver 54 is connected to this head unit 52 so as to control the discharge amount of the ink of each color. Furthermore, an ultraviolet ray irradiating section 56 is disposed just behind the image recording position 42P and in the downstream side of the head unit 52, thereby giving strong actinic energy ray necessary for putting the ink put on the recording medium S and curing it immediately thereafter.

A separating claw 92 is disposed in the downstream side at the position at which the recording medium S is separated from the traveling belt 42 (the position of the downstream belt roll 44c in this embodiment), and the tip of the separating claw 92 facilitates the separation of the recording medium S from the traveling belt 42 in the vicinity of the downstream belt roll 44c. The tray 90 accommodates the recording medium S which has been separated from the traveling belt 42.

In the ultraviolet ray irradiating section 56, since as described previously, strong light for curing the ink is used, an exhaust cooling section 80 is disposed in an upper part within the casing 12 for the purpose of suppressing an increase of the temperature within the casing 12. As other constructions, the recording medium accommodating section 20 can bb constructed as a cassette for feeding a recording material as wound around a roll. In this case, a cutter capable of cutting the recording material into a desired length is disposed in place of the feed roll 32 of the traveling section 30.

Next, this embodiment will be described along a series of motions using the drawings.

FIG. 2 is a partial perspective oblique view of the enlarged cartridge installing section 70.

FIG. 2 illustrates a state that cartridges 72a, 72b, 72c and 72d are installed in the cartridge installing section 70 and illustrates the cartridge 72a which is one of the cartridges in a partial perspective state. The respective cartridges 72a, 72b, 72c and 72d can be constructed such that they are individually freely detachable, and at the time of installing, these cartridges are connected to corresponding ink feed lines 74a, 74b, 74c and 74d, respectively. The ink feed lines 74a, 74b, 74c and 74d are disposed within the casing 12 of the ink-jet recording device 10 for an actinic energy ray-curable type ink and connected to the head unit 52.

With respect to stirring of the ink within each of the cartridges 72a, 72b, 72c and 72d, it will be described while representing the cartridge 72a which is illustrated as a perspective oblique view. Other cartridges 72b, 72c and 72d can be each made to have the same structure.

A magnetic rotor 62a as an ink stirring member is put into the cartridge 72a in advance. On the other hand, in the cartridge installing section 70, a rotary magnetic plate 64a as rotary magnetic section is disposed lateral to the cartridge 72a and in a position facing to this rotor 62a, and a rotary drive section 66a as drive section is supported by the casing 12. These rotor 62a, rotary magnetic plate 64a and rotary drive section 66a work as one set and act as an ink stirring unit 60a.

This rotary magnetic plate 64a rotates, and the rotor 62a starts to rotate due to its rotary magnetic force to stir the ink within the cartridge 72a, thereby controlling internal precipitation of the ink. As described previously, a unit the same as the ink stirring unit 60a can also be provided in other cartridges 72b, 72c and 72d.

The head driver 54 controls the ink stirring unit 60a. First of all, at a point of time when the cartridge 72a is installed in the cartridge installing section 70, the ink is stirred to produce a uniform mixed state. Furthermore, in the case where the power supply is turned off in a state that the cartridge 72a is installed in the cartridge installing section 70, stirring is started at the same time when the power supply is turned on, thereby achieving warm-up. Moreover, the control can also be carried out in such a manner that in the case where a downtime of the image formation is measured and the downtime of the image formation elapses such a degree that precipitation inside of the ink cartridge is actualized, stirring is automatically started.

Also, there may be taken a structure in which in the cartridge 72a, an inclination is provided in the bottom thereof such that the rotor 62a is moved to a prescribed position counterpart to the rotary magnetic plate 64a. Also, it is possible to form the cartridge as a double structure and provide a soft material for an inner bag thereof in a freely exchangeable manner.

In addition to the construction utilizing a magnetic force, for example, this ink stirring unit 60a can be constructed such that a stirring blade is provided within the cartridge and that only a shaft thereof is drawn out the cartridge while being shielded and connected to an external rotary drive unit. Also, the ink stirring unit 60a can be constructed such that a cartridge oscillation unit is provided in the cartridge installing section 70, thereby oscillating the cartridge to a degree that internal stirring is facilitated.

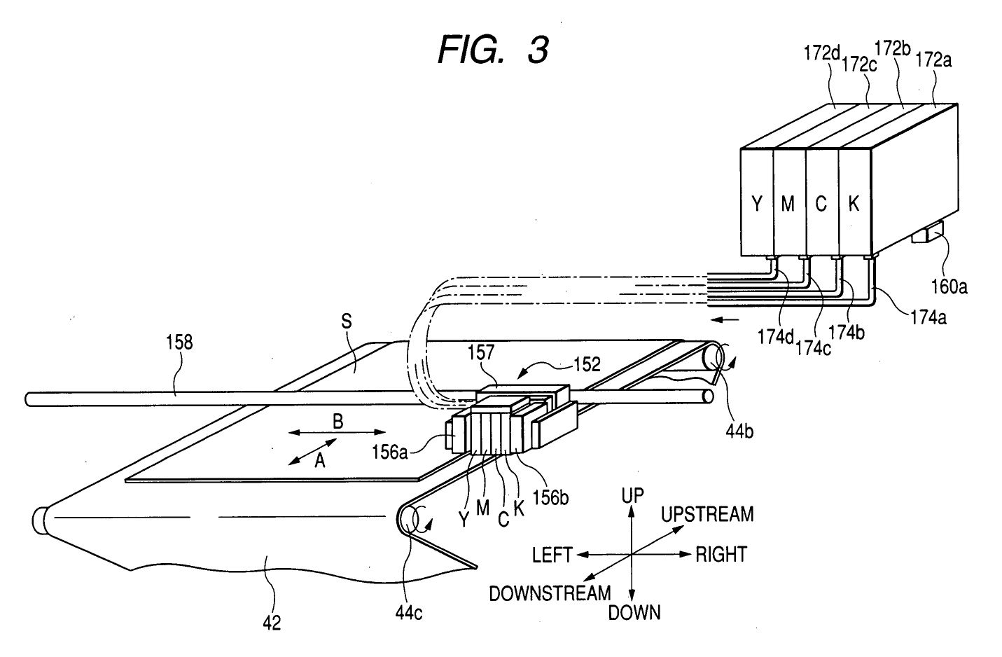

Incidentally, in this embodiment, a full-line head in which ink-jet nozzles stand in the widthwise direction of the recording medium S is employed as the head unit 52. However, as shown in FIG. 3, et seq. as described later, there can also be employed a construction in which a scanning type head capable of scanning vertically to the traveling direction of the recording medium S is employed as the head unit 52. In that case, there is employed a construction in which an ultraviolet ray irradiating section is provided in a form that it is operated together with the scanning type head. Furthermore, in this embodiment, the ink-jet recording position is traveled by the traveling belt. However, as other constructions, there can be employed a construction in which the recording medium is traveled on a platen at the ink-jet recording position while being interposed between the traveling rolls.

FIG. 3 is a partial schematic view to show other construction of the image recording section.

In the recording device 10 as shown in FIG. 1, the head 52 is a line type ink-jet head having ink discharge nozzles in the entire widthwise direction of the recording medium S. However, a head 152 as shown in FIG. 3 is of a multi-channel type and achieves scanning movement in the widthwise direction of the recording medium S, too. The construction will be hereunder described. Incidentally, in FIG. 3, elements having the same constructions and same actions as in FIG. 1 are given the same symbols.

First of all, likewise FIG. 1, a traveling belt 42 is tensioned and driven by three belt rolls 44a (not shown), 44b and 44c. The traveling belt 42 is driven in a direction from the upstream belt roll 44b to the downstream belt roll 44c; and a recording medium S is placed on the traveling belt 42 between the upstream belt roll 44b and the downstream belt roll 44c and traveled along a traveling direction A.

As a construction of an image recording section 150, it is composed of a guide member 158 extending in an orthogonal direction (scanning direction B) to the traveling direction A in the upper position of the recording medium S which is traveled between the upstream belt roll 44b and the downstream belt roll 44c and a head unit 152 which is suspended and supported by this guide member 158. This head unit 152 is set up in a freely reciprocally movable manner along the scanning direction B. Here, the head unit 152 is provided with a group of four nozzles from which respective actinic energy ray-curable type inks of four colors (yellow Y, magenta M, cyan C, and black K) are each injected towards the recording surface of the recording medium S.

A cartridge installing section 170 which is connected to the head unit 152 has a construction basically the same as the cartridge installing section 70 as shown in FIG. 2 and installed with cartridges 172a, 172b, 172c and 172d. The respective cartridges 172a, 172b, 172c and 172d can be constructed such that they are individually freely detachable, and at the time of installing, these cartridges are connected to corresponding ink feed lines 174a, 174b, 174c and 174d, respectively. The ink feed lines 174a, 174b, 174c and 174d are disposed within the casing 12 of the ink-jet recording device 10 for the actinic energy ray-curable-type and connected to a connecting section 157 provided on the head unit 152. Each of the ink feed lines 174a, 174b, 174c and 174d has a flexible construction such that it is adaptive to the movement of the head unit 152.

Furthermore, the cartridge 172a is provided with an ink stirring unit 160a having a construction the same as in the ink stirring unit 60a as shown in FIG. 2. With respect to each of the other cartridges 172b, 172c and 172d, it is possible to give the same construction and motion.

An ultraviolet ray irradiating section 156 is disposed in both sides of the head unit 152 in the longitudinal direction of the guide member 158. In both right and left sides of the head unit 152 in the drawing, two ultraviolet ray irradiating sections 156a and 156b for achieving irradiation with ultraviolet rays are mounted, respectively. The ultraviolet ray irradiating sections 156a and 156b are movable together by reciprocating movement of the head unit 152. An ultraviolet ray curable ink which has been discharged from each of the nozzles and impacted onto the recording medium S is irradiated with ultraviolet rays by one of the ultraviolet ray irradiating ray sections 156a and 156b passing thereon immediately thereafter.

Furthermore, in the upper position of the recording medium S, as shown in FIG. 1, there can also be employed a construction in which for the purpose of enhancing adhesion between the recording medium S and the traveling belt 42, a corona charger is provided at the position of the upstream belt roll 44b and a static eliminator is provided at the position of the downstream belt roll 44c.

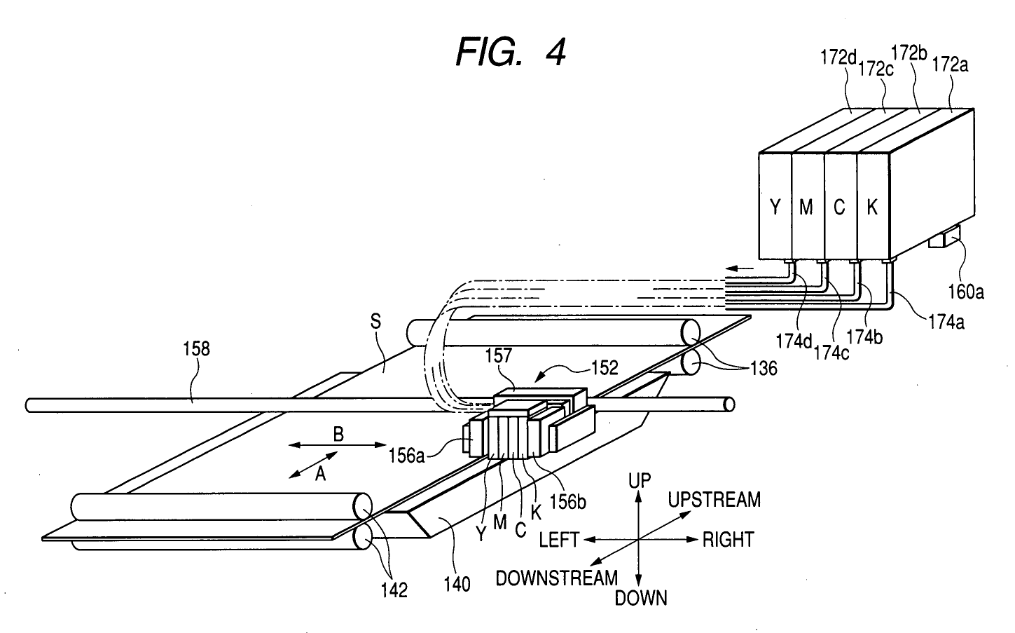

FIG. 4 is a schematic view to show a still other construction of the image recording section and is a schematic oblique view to show a construction in which image recording is carried out by the head 152 of a multi-channel type as shown in FIG. 3 and the traveling and scanning section using the fixed platen 140 as shown in FIG. 2.

In FIG. 4, first of all, likewise FIG. 2, a plate-like platen 140 supports a recording medium S, and a scanning and traveling roll pair 136 moves the recording medium S on the platen 140.

As in the image recording section as shown in FIG. 3, the head unit 152 for recording an image on the recording surface of the recording medium S is suspended and supported by a guide member 158 extending in an orthogonal direction (scanning direction B) to a traveling direction A above the platen 140. Ultraviolet ray irradiating sections 156a and 156b are movable together in the direction B by the reciprocating movement of the head unit 152. An ultraviolet ray curable ink which has been discharged from each of the nozzles and impacted onto the recording medium S is irradiated with ultraviolet rays by one of the ultraviolet ray irradiating sections 156a and 156b passing thereon immediately thereafter. Thereafter, a scanning and traveling roll pair 142 interposes the tip of the recording medium S and delivers it, whereby the recording medium S is sent out from the ink-jet recording device.

Incidentally, likewise FIG. 3, the cartridge installing section 170 is connected to the head unit 152 and installed with cartridges 172a, 172b, 172c and 172d. Furthermore, an ink stirring unit 160a of the same construction is disposed in a lower part of the cartridge 172a. With respect to each of the other cartridges 172b, 172c and 172d, it is possible to give the same construction and motion.

Furthermore, in the upper position of the recording medium S, as shown in FIG. 1, there can also be employed a construction in which for the purpose of enhancing adhesion between the recording medium S and the traveling belt 42, a corona charger is provided at the position of the upstream end of the platen 140 and a static eliminator is provided at the position of the downstream at which the scanning and traveling roll pair 142 interposes the tip of the recording medium S and delivers it. In this case, the platen 140 must be made of a conductive material.

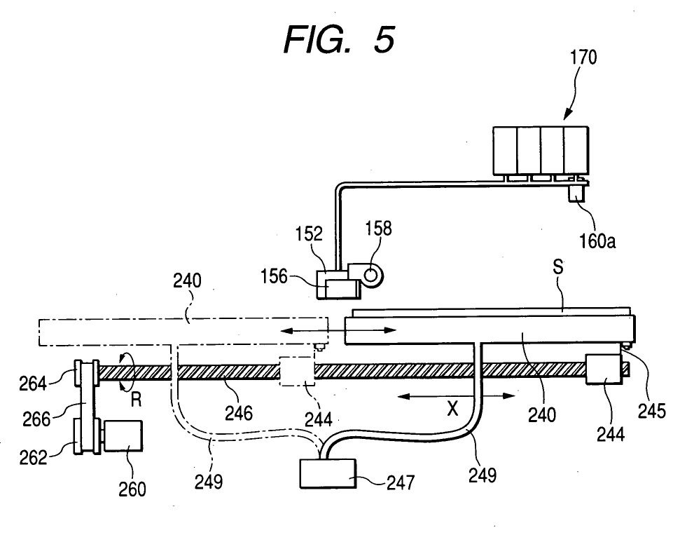

FIG. 5 is a constructive schematic view of the ink-jet recording device for an actinic energy ray-curable type ink according to another embodiment of the invention.

In FIG. 5, a movable platen 240 supports a recording medium S at the time of recording and traveling. It is preferable that the movable platen 240 is in a plate-like form and set up so as to have a size slightly larger than a maximum size of the recording medium S, thereby supporting the whole of the recording medium. On the back surface of the movable platen 240 opposing to the supporting surface of the recording material, a ball nut 244 is fixed by a bracket 245. A ball screw shaft 246 which penetrates this ball nut 244 is disposed such that its longitudinal direction is parallel to the traveling direction of the recording medium S. The ball nut 244 is engaged by teeth with the ball screw shaft 246 and regulated to fore and aft movement X of the traveling direction of the recording medium following rotation R of the ball screw shaft 246.

A driven timing pulley 264 is disposed in the downstream end of the traveling direction of the ball screw shaft 246. Furthermore, a drive motor 260 is disposed below the movable platen 240. A timing belt 266 is tensioned between a drive timing pulley 262 to be rotated and driven by this drive motor 260 and the driven timing pulley 264, thereby transmitting rotational drive. The rotation rotates the driven timing pulley 264 and rotates the ball screw shaft 246 by the drive motor 260. This rotation is finally converted into linear movement in the traveling direction of the recording medium by the ball nut 244. Then, the movable platen 240 is constructed such that it reciprocates between an initial position shown by a solid line and the most downstream position as expressed by a dashed line in FIG. 5.

In addition, plural intakes (not shown) are disposed on the surface of the movable platen 240 on which the recording medium is placed. These intakes are connected to a pipe within the platen and also connected to an intake pipe 249 as provided in a lower part of the movable platen 240. This intake pipe 249 is connected to an intake section 247 as disposed below the movable platen 240 and adsorbs the recording medium S as placed on the movable platen 240 due to the drive of this intake section 247.

The image recording section 150 as shown in FIG. 3 or FIG. 4 is disposed in the vicinity of the middle between the initial position and the downstream position of the movable platen 240 and above the movable platen 240. A head unit 152 of a multi-channel type is provided in this image recording section 150. This head unit 152 is suspended and supported by a guide member 158 extending in a scanning direction orthogonal to the fore and aft movement X of the traveling direction of the recording medium. The head unit 152 undergoes reciprocating movement and scanning along the guide member 158. However, the head unit 152 is basically provided with a group of four nozzles from which respective actinic energy ray-curable type inks of four colors (yellow Y, magenta M, cyan C, and black K) are each injected towards the recording surface of the recording medium S.

An ultraviolet ray irradiating section 156 is disposed in both sides of the head unit 152 in the longitudinal direction of the guide member 158. The ultraviolet ray irradiating section 156 is movable together by the reciprocating movement of the head unit 152, and ultraviolet rays are irradiated on an ultraviolet ray curable ink which has been discharged from each of the nozzles and impacted onto the recording medium S.

Furthermore, likewise FIG. 3 or FIG. 4, a cartridge installing section 170 is connected to the head unit 152, and cartridges of respective colors are installed therein. Moreover, an ink stirring unit 160a of the same construction and motion is disposed in a lower part of at least one cartridge.

Next, the motion of this embodiment will be described. First of all, in the case of this embodiment, everyone sheet of the recording medium S is manually fed into the recording device as the need arises. The recording medium S to be manually fed is placed on the movable platen 240 which is present at the initial position. The movable platen 240 keeps a stopped state until the whole of the recording medium S has been completely placed thereon.

In the ink stirring unit 160a, stirring of the ink within the cartridge is completed at least prior to this state. Accordingly, with respect to the stirring timing, it is optimal that the stirring is carried out at least at intervals to a degree that precipitation of the ink within the cartridge is Visualized. Besides this timing, the stirring can be carried out at the time of installing a cartridge in the cartridge installing section 170, or the stirring can be continuously carried out.

Next, image recording is carried out by an image recording start button (not shown) as provided in the image recording device. The intake section 247 is driven at latest at this timing, and the recording medium S as placed on the movable platen 240 is adsorbed. Furthermore, driving is started due to the movement of the movable plate 240 by the drive motor 260 at this timing.

Here, a rotary power of the drive motor 260 is transmitted into the drive timing pulley 262, the timing belt 266 and the driven timing pulley 264, thereby rotating the ball screw shaft 246. This rotation is converted into linear movement in the downstream direction by the ball nut 244.

Then, the movable platen 240 moves from the initial position to the most downstream-position (expressed by the dashed line). At this time, image recording by the image recording section 250 is started. That is, the ball nut 244 is moved at a rate for image recording, and image recording and scanning is executed for the recording medium S on the simultaneously moved movable platen 240 by the head unit 152. Then, after completion of the image recording, the recorded recording medium S is manually recovered from the top of the platen 240 which has been subjected to static elimination at the most downstream position (expressed by the dashed line).

After removal of the recording medium S, the movable platen 240 at the most downstream position (expressed by the dashed line) is returned to the original position due to reverse drive of the drive motor 260 and provided for next image recording.

The term “actinic energy ray” as referred to in the invention is not particularly limited so far as it can impart energy capable of generating an initiation seed in the ink composition by its irradiation and widely includes α-rays, γ-rays, X-rays, ultraviolet rays, visible rays, and electron beams. Above all, from the viewpoints of curing sensitivity and easiness of availability of the device, ultraviolet rays and electron beams are preferable; and ultraviolet rays are especially preferable. Accordingly, it is preferable that the ink composition of the invention is an ink composition which can be cured by irradiation with ultraviolet rays.

In the ink-jet recording device of the invention, though a peak wavelength of the actinic energy ray varies with absorption characteristics of a sensitizing dye in the ink composition, it is suitable that the peak wavelength is, for example, from 200 to 600 nm, preferably from 300 to 450 nm, and more preferably from 350 to 450 nm. Furthermore, (a) an electron transfer type initiation system of the ink composition of the invention has sufficient sensitivity even to actinic energy ray with a low output. Accordingly, with respect to an output of the actinic energy ray, it is suitable that its irradiation energy is, for example, not more than 2,000 mJ/cm², preferably from 10 to 2,000 mJ/cm², more preferably from 20 to 1,000 mJ/cm², and further preferably from 50 to 800 mJ/cm². Furthermore, it is suitable that the actinic energy ray is irradiated at a luminance on the exposed surface (maximum luminance on the surface of a medium to be recorded) of, for example, from 10 to 2,000 mW/cm², and preferably from 20 to 1,000 mW/cm².

In particular, in the ink-jet recording device of the invention, it is preferable that the irradiation with actinic energy ray is achieved by irradiation from a light emitting diode capable of emitting ultraviolet rays such that its luminescence wavelength peak is from 390 to 420 nm and that the maximum luminance on the surface of the medium to be recorded is from 10 to 1,000 mW/cm².

Furthermore, in the ink-jet recording device of the invention, it is suitable that the actinic energy ray is irradiated on the ink composition as discharged onto the medium to be recorded for, for example, from 0.01 to 120 seconds, and preferably from 0.1 to 90 seconds.

In addition, in the ink-jet recording device of the invention, it is desired that not only the ink composition is warmed at a fixed temperature, but also the time from impacting of the ink composition against the medium to be recorded until the irradiation with actinic energy ray is set up at from 0.01 to 0.5 seconds, preferably from 0.01 to 0.3 seconds, and more preferably from 0.01 to 0.15 seconds. By controlling the time from impacting of the ink composition against the medium to be recorded until the irradiation with actinic energy ray within an extremely short period of time, it becomes possible to prevent oozing prior to curing of the impacted ink composition from occurring.

Incidentally, in order to obtain a color image using the ink-jet recording device of the invention, it is preferred to superimpose inks in order from an ink with low brightness. By such superimposition, the actinic energy ray is liable to reach even the inks in the lower part, and good curing sensitivity, reduction of residual monomers, reduction of odors and improvement of adhesion can be expected. Furthermore, with respect to the irradiation with active energy, though it is possible to achieve exposure by collectively injecting full colors, it is preferable from the viewpoint of promotion of curing that the exposure is carried out for every color.

The ink-jet head of the invention can be driven so as to inject multi-size dots of, for example, from 1 to 100 pl, and preferably from 8 to 30 pl at a resolution of, for example, from 320×320 to 4,000×4,000 dpi, and preferably 400×400 to 2,400×2,400 dpi using a piezoelectric type ink-jet head. Incidentally, the term “dpi” as referred to in the invention expresses the number of dots per 2.54 cm.

Furthermore, as described previously, with respect to an actinic energy ray-curable type ink such as the ink composition of the invention, it is desired that the ink composition to be discharged is set up at a fixed temperature. Thus, it is preferable that from an ink feed tank to an ink-jet head portion are subjected to temperature control by heat insulation and warming. Moreover, it is preferable that the head unit for achieving heating is thermally shielded or heat insulated such that the device main body is not affected by the temperature from the outside air. In order to shorten the rise time of a printer which is required to be heated or to reduce a loss of the heat energy, it is preferable that not only heat insulation from other sites is achieved, but also a heat capacity of the whole of the heating unit is made small.

Furthermore, as a source of the actinic energy ray, a mercury vapor lamp, gas or solid lasers, and so on are mainly utilized. For the ultraviolet ray curing type ink-jetting, a mercury vapor lamp and a metal halide lamp are broadly known. Moreover, replacement for a GaN based semiconductor ultraviolet ray emitting device is very useful industrially and environmentally. In addition, LED (UV-LED) and LD (UV-LD) are small in size, long in life, high in efficiency and low in costs and are expected as a radiation source of the ink-jet recording device for the actinic energy ray-curable type ink.

Furthermore, as described previously, it is possible to use, as the source of the actinic energy ray, a light emitting diode (LED) and a laser diode (LD). In particular, in the case where an ultraviolet ray source is required, ultraviolet LED and ultraviolet LD can be used. For example, Nichia Corporation markets a violet LED a major emission spectrum of which has a wavelength between 365 nm and 420 nm. In addition, in the case where a much shorter wavelength is required, U.S. Pat. No. 6,084,250 discloses LED capable of emitting actinic energy ray as centralized between 300 nm and 370 nm. Also, other ultraviolet LEDs are available, and radiations having a different ultraviolet ray band can be irradiated. In particular, the source of the actinic energy ray which is preferable in the invention is UV-LED, and UV-LED having a peak wavelength of from 350 to 420 nm is especially preferable.

(Medium to be Recorded)

The medium to be recorded to which the ink composition of the invention is applicable is not particularly limited, and useful examples thereof include papers such as usual non-coated papers and coated papers and various non-absorbing resin materials which are used for so-called flexible packaging or resin films resulting from molding such a resin material into a film. Examples of various plastic films which can be used include PET films, OPS films, OPP films, ONy films, PVC films, PE films, and TAC films. Besides, examples of plastics which can be used as the medium to be recorded include polycarbonates, acrylic resins, ABS, polyacetals, PVA, and rubbers. Metals and glasses can also be used as the medium to be recorded.

In the ink composition of the invention, in the case where a material which is low in heat shrinkage at the time of curing is selected, it is excellent in adhesion between the cured ink composition and the medium to be recorded. Thus, there is an advantage that a high-definition image can be formed even by using a film which is liable to cause curling or deformation due to curing and shrinkage of the ink or the heat generation at the time of curing reaction, such as PET films, OPS films, OPP films, ONy films, and PVC films, all of which are shrinkable by heat.

The respective constitutional components to be used in the ink composition which can be used in the invention will be hereunder described in order.

(Ink Composition)

The ink composition which is used in the invention is an ink composition which is curable by irradiation with actinic energy ray, and examples thereof include a cationic polymerization based ink composition, a radical polymerization based ink composition, and an aqueous ink composition. These compositions will be hereunder described in detail.

(Cationic Polymerization Based Ink Composition)

The cationic polymerization based ink composition contains (a) a cationic polymerizable compound and (b) a compound capable of generating an acid by irradiation with actinic energy ray. If desired, the cationic polymerization based ink composition may further contain (d) an organic acidic component having a pk value of from 2 to 6, (e) a coloring agent, and the like.

The respective constitutional components which are used in the cationic polymerization based ink composition will be hereunder described in order.

((a) Cationic Polymerizable Compound)

The cationic polymerizable compound (a) which is used in the invention is not particularly limited so far as it is a compound which causes a polymerization reaction due to an acid as generated from (b) a compound capable of generating an acid by irradiation with actinic energy ray as described later and is then cured, and various known cationic polymerizable monomers which are known as a photo cationic polymerizable monomer can be used. Examples of the cationic polymerizable monomer include epoxy compounds, vinyl ether compounds, and oxetane compounds as described in, for example, JP-A-6-009714, JP-A-2001-031892, JP-A-2001-040068, JP-A-2001-055507, JP-A-2001-310938, JP-A-2001-310937, and JP-A-2001-220526.

Examples of the epoxy compound include aromatic epoxides, alicyclic epoxides, and aliphatic epoxides.

As the aromatic epoxide, there are enumerated di- or polyglycidyl ethers resulting from a reaction of a polyhydric phenol having at least one aromatic nucleus or an alkylene oxide adduct thereof with epichlorohydrin. Examples thereof include di- or polyglycidyl ethers of bisphenol A or an alkylene oxide adduct thereof, di- or polyglycidyl ethers of hydrogenated bisphenol A or an alkylene oxide adduct, and novolak type-epoxy resins. Here, examples of the alkylene oxide include ethylene oxide and propylene oxide.

As the alicyclic epoxide, there are preferably enumerated cyclohexene oxide-containing or cyclopentene oxide-containing compounds which are obtained by epoxidizing a compound having at least one cycloalkene ring such as a cyclohexene ring and a cyclopentene ring with a suitable oxidizing agent such as hydrogen peroxide and peracids.

As the aliphatic epoxide, there are enumerated di- or polyglycidyl ethers of an aliphatic polyhydric alcohol or an alkylene oxide adduct thereof. Representative examples thereof include diglycidyl ethers of an alkylene glycol such as diglycidyl ether of ethylene oxide, diglycidyl ether of propylene glycol, and diglycidyl ether of 1,6-hexanediol; polyglycidyl ethers of a polyhydric alcohol such as di- or triglycidyl ethers of glycerin or an alkylene oxide adduct thereof; and diglycidyl ethers of a polyalkylene glycol represented by diglycidyl ethers of polyethylene glycol or an alkylene oxide adduct thereof and diglycidyl ethers of polypropylene glycol or an alkylene oxide adduct thereof. Here, examples of the alkylene oxide include ethylene oxide and propylene oxide.

The epoxy compound may be monofunctional or polyfunctional.

Examples of the monofunctional epoxy compound which can be used in the invention include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monoxide, 1,2-epoxydodecane, epichlorohydrin, 1,2-epoxydecane, styrene oxide, cyclohexene oxide, 3-methacryloyloxymethylcyclohexene oxide, 3-acryloyloxymethylcyclohexene oxide, and 3-vinylcyclohexene oxide.

Furthermore, examples of the polyfunctional epoxy compound include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolak resins, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexane carboxylate, 2-(3,4-epoxy-cyclohexyl-5,5-spiro-3,4-epoxy)cyclohexane-m-dioxane, bis-(3,4-epoxycyclohexylmethyl) adipate, vinylcyclohexene oxide, 4-vinylepoxycyclohexane, bis(3,4-epoxy-6-methylcyclohexylmethyl) adipate, 3,4-epoxy-6-methylcyclohexyl-3′,4′-epoxy-6′-methylcyclohexane carboxylate, methylenebis(3,4-epoxycyclohexane), dicyclopentadiene diepoxide, di(3,4-epoxycyclohexylmethyl) ether of ethylene glycol, ethylene-bis(3,4-epoxycyclohexane carboxylate), dioctyl epoxyhexahydrophthalate, di-2-ethylhexyl epoxyhexahydrophthalate, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ethers, 1,1,3-tetradecadiene dioxide, limonene dioxide, 1,2,7,8-diepoxyoctane, and 1,2,5,6-diepoxycyclooctane.

Of these epoxy compounds, from the viewpoint of excellent curing rate, aromatic epoxides and alicyclic epoxides are preferable; and alicyclic epoxides are especially preferable.

Examples of the vinyl ether compound include di- or trivinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether; and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-O-propylene carbonate, dodecyl vinyl ether, diethylene glycol monovinyl ether, and octadecyl vinyl ether.

The vinyl ether compound may be monofunctional or polyfunctional.

Concretely, examples of the monofunctional vinyl ether include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Furthermore, examples of the polyfunctional vinyl ether include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ethers, and bisphenol F alkylene oxide divinyl ethers; and polyfunctional vinyl ethers such as trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, ethylene oxide-added trimethylolpropane trivinyl ether, propylene oxide-added trimethylolpropane trivinyl ether, ethylene oxide-added ditrimethylolpropane tetravinyl ether, propylene oxide-added ditrimethylolpropane tetravinyl ether, ethylene oxide-added pentaerythritol tetravinyl ether, propylene oxide-added pentaerythritol tetravinyl ether, ethylene oxide-added dipentaerythritol hexavinyl ether, and propylene oxide-added dipentaerythritol hexavinyl ether.

As the vinyl ether compound, from the viewpoints of curing properties, adhesion to the medium to be recorded and surface hardness of the formed image, di- or trivinyl ether compounds are preferable; and divinyl ether compounds are especially preferable.

The oxetane compound as referred to in the invention means a compound having an oxetane ring and can be arbitrarily selected and used among known oxetane compounds as described in JP-A-2001-220526, JP-A-2001-310937, and JP-A-2003-341217.

As the compound having an oxetane ring which can be used in the ink composition of the invention, compounds having from one to four oxetane rings in the structure thereof are preferable. By using such a compound, it becomes easy to keep the ink composition so as to make a viscosity fall within the range suitable for handling properties. Furthermore, it is possible to obtain high adhesion between the ink composition and the medium to be recorded after curing.

Such a compound having an oxetane ring is described in detail in paragraphs [0021] to [0084] of JP-A-2003-341217, and compounds as described in this patent document can also be suitably used in the invention.

Of the oxetane compounds which are used in the invention, it is preferred to use a compound having one oxetane ring from the viewpoints of viscosity and adhesiveness of the ink composition.

In the ink composition of the invention, such a cationic polymerizable compound may be used singly or in combination of two or more kinds thereof. However, from the viewpoint of the matter that shrinkage at the time of curing of the ink is effectively controlled, it is preferred to use a combination of at least one compound selected from oxetane compounds and epoxy compounds with a vinyl ether compound.

The content of the cationic polymerizable compound (a) in the ink composition is suitably in the range of from 10 to 95% by weight, preferably from 30 to 90% by weight, and more preferably from 50 to 85% by weight with respect to the whole of solids of the composition.

((b) Compound Capable of Generating an Acid by Irradiation with Actinic Energy Ray)

The ink composition of the invention contains a compound capable of generating an acid by irradiation with actinic energy ray (hereinafter properly referred to as “photo acid generating agent”).

As the photo acid generating agent which can be used in the invention, compounds capable of generating an acid by irradiation of rays (for example, ultraviolet rays and far ultraviolet rays having a wavelength of from 400 to 200 nm; especially preferably g-rays, h-rays, i-rays, and KrF excimer lasers), ArF excimer lasers, electron beams, X-rays, molecular rays, or ion beams, which are used in photo cationic polymerization photoinitiators, photo radical polymerization photoinitiators, photo decolorizing agents of dyes, photo discoloring agents, or micro resists, can be properly selected and used.

Examples of such a photo acid generating agent include compounds which are decomposed by irradiation with actinic energy ray to generate an acid such as onium salts (for example, diazonium salts, ammonium salts, phosphonium salts, iodonium salts, sulfonium salts, selenonium salts, and arsonium salts), organic halogen compounds, organic metals or organic halides, photo acid generating agents having an o-nitrobenzyl type protective group, compounds which are photo decomposed to generate sulfonic acid, represented by imino sulfonate, disulfone compounds, diazo keto sulfone, and diazo disulfone compounds.

Also, oxazole derivatives and s-triazine derivatives as described in paragraphs [0029] to [0030] of JP-A-2002-122994 can be suitably used as the photo acid generating agent. In addition, onium salt compounds and sulfonate based compounds as enumerated in paragraphs [0037] to [0063] of JP-A-2002-122994 can be suitably used as the photo acid generating agent in the invention.

The photo acid generating agent (b) can be used singly or in combination with two or more kinds thereof.

The content of the photo acid generating agent (b) in the ink composition is preferably from 0.1 to 20% by weight, more preferably from 0.5 to 10% by weight, and further preferably from 1 to 7% by weight with respect to the whole of solids of the ink composition.

In addition to the foregoing essential components, various additives can be used jointly in the ink composition of the invention depending upon the purpose. These arbitrary components will be hereunder described.

((d) Organic Acidic Component Having a pk Value of from 2 to 6)

In the ink composition of the invention, (d) an organic acidic component exhibiting a pKa of from 2 to 6 can be added. The organic acidic component (d) having a pK value of from 2 to 6 which is used in the invention is corresponding to a qualitatively weakly acidic organic compound. In the case where the pKa of the organic acidic component is larger than 6, when added in the ink composition of the invention, the sensitivity is lowered, whereas in the case where the pKa is smaller than 2, deterioration in stability with time of the ink composition is caused. Therefore, in the invention, it is preferred to apply a substance exhibiting a pKa value of from 2 to 6 as the organic acidic component.

As a specific compound of the organic acidic components exhibiting a pKa value of from 2 to 6, carboxylic acids are especially enumerated. Examples of the carboxyl acid include aliphatic or aromatic monocarboxylic acids, dicarboxylic acids or tricarboxylic acids having from 1 to 20 carbon atoms, such as acetic acid, phenylacetic acid, phenoxyacetic acid, methoxypropionic acid, lactic acid, hexanoic acid, heptanoic acid, octanoic acid, palmitic acid, stearic acid, oleic acid, linoleic acid, cyclopropylcarboxylic acid, cyclobutanecarboxylic acid, cyclopentanecarboxylic acid, cyclohexanecarboxylic acid, 1-adamantanecarboxylic acid, 1,3-adamantanedicarboxylic acid, norbornene-2,3-dicarboxylic acid, abietic acid, trans-retinoic acid, cyclohexylacetic acid, dicyclo-hexylacetic acid, adamantaneacetic acid, malonic acid, monomethyl malonate, fumaric acid, maleic acid, monomethyl maleate, itaconic acid, crotonic acid, succinic acid, adipic acid, sebacic acid, glycolic acid, diglycolic acid, mandelic acid, tartaric acid, malic acid, alginic acid, cinnamic acid, methoxycinnamic acid, 3,5-dimethoxycinnamic acid, benzoic acid, salicylic acid, 4-hydroxybenzoic acid, gallic acid, 3-nitrobenzoic acid, 3-chlorobenzoic acid, 4-vinylbenzoic acid, t-butylbenzoic acid, 1-naphthoic acid, 1-hydroxy-2-naphthoic acid, fluorenone-2-carboxylic acid, 9-anthracenecarboxylic acid, 2-anthraquinonecarboxylic acid, phthalic acid, monomethyl phthalate, isophthalic acid, terephthalic acid, trimellitic acid, and monomethyl trimellitate. However, it should not be construed that the invention is limited thereto.

((e) Coloring Agent)

In the ink composition of the invention, by adding a coloring agent, it is possible to form a visible image. For example, in the case of forming an image area region of a lithographic printing plate, though it is not always required to add a coloring agent, it is preferred to use a coloring agent from the viewpoint of plate inspection properties of the resulting lithographic printing plate.

The coloring agent which can be used herein is not particularly limited but can be properly selected and used among various known coloring materials (for example, pigments and dyes) depending upon the utilization. For example, in the case of forming an image having excellent weather resistance, a pigment is preferable. As the dye, though any of water-soluble dyes and oil-soluble dyes can be used, oil-soluble dyes are preferable.

(Pigment)

The pigment which is preferably used in the invention will be hereunder described.

The pigment is not particularly limited. For example, all organic pigments and inorganic pigments which are generally commercially available, substances resulting from dispersing a pigment in, as a dispersion medium, an insoluble resin, etc., and substances resulting from grafting a resin on the surface of a pigment can be used. Substances resulting from dyeing a resin particle with a dye can also be used.

Examples of such a pigment include pigments as described in Ganryo No Jiten (Pigment Dictionary), edited by Seishiro ITO (published in 2000), W. Herbst and K. Hunger, Industrial Organic Pigments, JP-A-2002-12607, JP-A-2002-188025, JP-A-2003-26978, and JP-A-2003-342503.

Specific examples of the organic pigment and the inorganic pigment which can be used in the invention are as follows. That is, examples of pigments which exhibit a yellow color include monoazo pigments such as C.I. Pigment Yellow 1 (for example, Fast Yellow G) and C.I. Pigment Yellow 74; disazo pigments such as C.I. Pigment Yellow 12 (for example, Disazo Yellow AAA) and C.I. Pigment Yellow 17; non-benzidine based azo pigments such as C.I. Pigment Yellow 180; azo lake pigments such as C.I. Pigment Yellow 100 (for example, Tartrazine Yellow Lake); condensed azo pigments such as C.I. Pigment Yellow 95 (for example, Condensed Azo Yellow GR); acid dye lake pigments such as C.I. Pigment Yellow 115 (for example, Quinoline Yellow Lake); basic dye lake pigments such as C.I. Pigment Yellow 18 (for example, Thioflavine Lake); anthraquinone based pigments such as Flavanthrone Yellow (Y-24); isoindolinone pigments such as Isoindolinone Yellow 3RLT (Y-110); quinophthalone pigments such as Quinophthalone Yellow (Y-138); isoindoline pigments such as Isoindoline Yellow (Y-139); nitroso pigments such as C.I. Pigment Yellow 153 (for example, Nickel Nitroso Yellow); and metal complex salt azomethine pigments such as C.I. Pigment Yellow 117 (for example, Copper Azomethine Yellow).

Examples of pigments which exhibit a red or magenta color include monoazo based pigments such as C.I. Pigment Red 3 (for example, Toluidine Red); disazo pigments such as C.I. Pigment Red 38 (for example, Pyrazolone Red B); azo lake pigments such as C.I. Pigment Red 53:1 (for example, Lake Red C) and C.I. Pigment Red 57:1 (for example, Brilliant Carmine 6B); condensed azo pigments such as C.I. Pigment Red 144 (for example, Condensed Azo Lake BR); acid dye lake pigments such as C.I. Pigment Red 174 (for example, Phloxine B Lake);

basic dye lake pigments such as C.I. Pigment Red 81 (for example, Rhodamine 6G′ Lake); anthraquinone based pigments such as C.I. Pigment Red 177 (for example Dianthraquinonyl Red); thioindigo pigments such as C.I. Pigment Red 88 (for example, Thioindigo Bordeaux); perinone pigments such as C.I. Pigment Red 194 (for example, Perinone Red);

perylene pigments such as C.I. Pigment Red 149 (for example, Perylene Scarlet); quinacridone pigments such as C.I. Pigment Violet 19 (for example, unsubstituted quinacridone) and C.I. Pigment Red 122 (for example, Quinacridone Magenta); isoindolinone pigments such as C.I.

Pigment Red 180 (for example, Isoindolinone Red 2BLT); and alizarine lake pigments such as C.I. Pigment Red 83 (for example, Madder Lake).

Examples of pigments which exhibit a blue or cyan color include disazo based pigments such as C.I. Pigment Blue 25 (for example, Dianisidine Blue); phthalocyanine pigments such as C.I. Pigment Blue 15 (for example, Phthalocyanine Blue); acid dye lake pigments such as C.I. Pigment Blue 24 (for example, Peacock Blue Lake); basic dye lake pigments such as C.I. Pigment Blue 1 (for example, Victoria Pure Blue BO Lake); anthraquinone based pigments such as C.I. Pigment Blue 60 (for example, Indanthrone Blue), and alkali blue pigments such as C.I. Pigment Blue 18 (for example, Alkali Blue V-5:1).

Examples of pigments which exhibit a green color include phthalocyanine pigments such as C.I. Pigment Green 7 (Phthalocyanine Green) and C.I. Pigment Green 36 (Phthalocyanine Green); and azo metal complex pigments such as C.I. Pigment Green 8 (Nitroso Green).

Examples of pigments which exhibit an orange color include isoindoline based pigments such as C.I. Pigment Orange 66 (Isoindoline Orange); and anthraquinone based pigments such as C. I. Pigment Orange 51 (Dichloropyranthrone Orange).

Examples of pigments which exhibit a black color include carbon black, titanium black, and aniline black.

Specific examples of white pigments which can be used-include basic lead carbonate (2PbCO₃Pb(OH)₂, so-called “silver white”), zinc oxide (ZnO, so-called “zinc white”), titanium oxide (TiO₂, so-called “titanium white”), strontium titanate (SrTiO₃, so-called “titanium strontium white”).

Here, titanium oxide has a low specific gravity and a high refractive index and is chemically and physically stable as compared with other white pigments. Thus, the titanium oxide has large covering power and coloring power as a pigment and has excellent durability against acids, alkalis and other environments. Accordingly, it is preferred to use titanium oxide as the white pigment. As a matter of course, other white pigments (other white pigments than those as enumerated previously may also be used) may be used as the need arises.

For dispersing the pigment, dispersing units such as a ball mill, a sand mill, an attritor, a roll mill, a jet mill, a homogenizer, a paint shaker, a kneader, an agitator, a Henschel mixer, a colloid mill, an ultrasonic homogenizer, a pearl mill, and a wet jet mill can be employed.

In dispersing the pigment, it is also possible to add a dispersant. Examples of the dispersant include hydroxyl group-containing carboxylic acid esters, salts between a long chain polyaminoamide and a high molecular acid ester, salts of a high molecular polycarboxylic acid, high molecular unsaturated acid esters, high molecular copolymers, modified polyacrylates, aliphatic polyhydric carboxylic acids, naphthalenesulfonic acid formalin condensates, polyoxyethylene alkylphosphoric esters, and pigment derivatives. It is also preferred to use a commercially available high molecular dispersant such as Zeneca's SOLSPERSE Series.

Furthermore, it is possible to use, as a dispersing agent, a synergist adaptive to a pigment of every kind. It is preferable that such a dispersant or dispersing agent is added in an amount of from 1 to 50 parts by weight based on 100 parts by weight of the pigment.

In the ink composition, a solvent may be added as a dispersion medium for various components inclusive of the pigment. Also, the foregoing cationic polymerizable compound (a) which is a low molecular component may be used as the dispersion medium in the absence of a solvent. However, since the ink composition of the invention is an actinic energy ray-curable type ink and after applying on the medium to be recorded, the ink is cured, it is preferred that the ink composition is free from a solvent. This is because when the solvent remains in the cured ink image, the solvent resistance is deteriorated or the residual solvent causes a problem of VOC (volatile organic compound). In view of the foregoing, what the cationic polymerizable compound (a) is used as the dispersion medium, especially a cationic polymerizable monomer having the lowest viscosity is selected is preferable from the viewpoints of dispersing adaptability and improvement of handling properties of the ink composition.

An average particle size of the pigment is preferably in the range of from 0.02 to 4 μm, more preferably from 0.02 to 2 μm, and further preferably from 0.02 to 1.0 μm.

In order to make the average particle size of the pigment particle fall within the foregoing preferred range, the pigment, the dispersant and the dispersion medium are selected, and the dispersing condition and the filtration condition are set up. By managing the particle size, it is possible to control plugging of a head nozzle and to keep the storage stability of the ink and the transparency and curing sensitivity of the ink.

(Dye)

As the dye which is used in the invention, an oil-soluble dye is preferable. Concretely, the oil-soluble dye is a dye having a solubility in water at 25° C. (weight of the dye which is dissolved in 100 g of water) of not more than 1 g, preferably not more than 0.5 g, and more preferably not more than 0.1 g. Accordingly, a so-called water-insoluble and oil-soluble dye is preferably used.

In the dye which is used in the invention, it is also preferred to introduce an oil-solubilizing group into the mother nucleus of the foregoing dye for the purpose of dissolving a necessary amount of the dye in the ink composition.

Examples of the oil-solubilizing group include a long chain or branched alkyl group, a long chain or branched alkoxy group, a long chain or branched alkylthio group, a long chain or branched alkylsulfonyl group, a long chain or branched acyloxy group, a long chain or branched alkoxycarbonyl group, a long chain or branched acyl group, a long chain or branched acylamino group, a long chain or branched alkylsulfonylamino group, and a long chain or branched alkylaminosulfonyl group; and an aryl group, an aryloxy group, an aryloxycarbonyl group, an arylcarbonyloxy group, an arylaminocarbonyl group, an arylaminosulfonyl group, and an arylsulfonylamino group each containing the foregoing long chain or branched substituent.

Furthermore, with respect to the water-soluble dye having a carboxyl acid or a sulfonic acid, a dye may be obtained by converting it into an oil-solubilizing group including an alkoxycarbonyl group, an aryloxycarbonyl group, an alkylaminosulfonyl group, and an arylaminosulfonyl group using a long chain or branched alcohol, amine, phenol or aniline derivative.

The oil-soluble dye is preferably an oil-soluble dye having a melting point of not higher than 200° C., more preferably an oil-soluble dye having a melting point of not higher than 150° C., and further preferably an oil-soluble dye having a melting point of not higher than 100° C. By using an oil-soluble dye having a low melting point, deposition of a crystal of the dye in the ink composition is controlled, and the storage stability of the ink composition is improved.

Furthermore, for the purpose of improving fading, especially resistance to oxidizers such as ozone and curing characteristics, it is preferable that the oxidation potential is noble (high). For that reason, an oil-soluble dye having an oxidation potential of 1.0 V (vs SCE) or more is preferably used as the oil-soluble dye to be used in the invention. It is preferable that the oxidation potential is higher. The oxidation potential is more preferably 1.1 V (vs SCE) or more, and especially preferably 1.15 V (vs SCE) or more.

As a dye having a yellow color, compounds having a structure represented by the general formula (Y-I) as described in JP-A-2004-250483 are preferable.

Dyes represented by the general formulae (Y-II) to (Y-IV) as described in paragraph [0034] of JP-A-2004-250483 are especially preferable. Specific examples thereof include compounds as described in paragraphs [0060] to [0071] of JP-A-2004-250483. Incidentally, the oil-soluble dyes of the general formula (Y-I) as described in the subject patent document may be used for inks of any colors including not only yellow inks but also black inks and red inks.

As a dye having a magenta color, compounds having a structure represented by the general formulae (3) and (4) as described in JP-A-2002-114930 are preferable. Specific examples thereof include compounds as described in paragraphs [0054] to [0073] of JP-A-2002-114930.

Azo dyes represented by the general formulae (M−1) to (M−2) as described in paragraphs [0084] to [0122] of JP-A-2002-121414 are especially preferable. Specific examples thereof include compounds as described in paragraphs [0123] to [0132] of JP-A-2002-121414. Incidentally, the oil-soluble dyes of the general formulae (3), (4) and (M−1) to (M−2) as described in the subject patent document may be used for inks of any colors including not only magenta inks but also black inks and red inks.

As a dye having a cyan color, dyes represented by the general formulae (I) to (IV) as described in JP-A-2001-181547 and dyes represented by the general formulae (IV-1) to (IV-4) as described in paragraphs [0063] to [0078] of JP-A-2002-121414 are preferable. Specific examples thereof include compounds as described in paragraphs [0052] to [0066] of JP-A-2001-181547 and compounds as described in paragraphs [0079] to [0081] of JP-A-2002-121414.

Phthalocyanine dyes represented by the general formulae (C-I) and (C-II) as described in paragraphs [0133] to [0196] of JP-A-2002-121414 are especially preferable, with phthalocyanine dues represented by the general formula (C-II) being further preferable. Specific examples thereof include compounds as described in paragraphs [0198] to [0201] of JP-A-2002-121414. Incidentally, the oil-soluble dyes of the foregoing general formulae (I) to (IV), (IV-1) to (IV-4), (C-I) and (C-II) may be used for inks of any colors including not only cyan inks but also black inks and green inks.

Such a coloring agent is preferably added in an amount of from 1 to 20% by weight, and more preferably from 2 to 10% by weight with respect to the whole of solids in the ink composition.

(Other Components)

Various additives which are used depending upon the situation will be hereunder described.

(Ultraviolet Ray Absorber)

In the invention, an ultraviolet ray absorber can be used from the viewpoints of improving the weather resistance and preventing the fading on the resulting image.

Examples of the ultraviolet ray absorber include benzotriazole based compounds described in JP-A-58-185677, JP-A-61-190537, JP-A-2-000782, JP-A-5-197075, and JP-A-9-034057; benzophenone based compounds as described in JP-A-46-002784, JP-A-5-194483, and U.S. Pat. No. 3,214,463; cinnamic acid based compounds as described in JP-B-48-30492 (the term “JP-B” as used herein means an “examined Japanese patent application), JP-B-56-021141, and JP-A-10-088106; triazine based compounds as described in JP-A-4-298503, JP-A-8-053427, JP-A-8-239368, JP-A-10-182621, and JP-T-8-501291; compounds as described in Research Disclosure, No. 24239; compounds capable of absorbing ultraviolet rays to emit fluorescence, as represented by stilbene based compounds and benzoxazble based compounds; and so-called fluorescent brighteners.

Though the amount of addition of the ultraviolet ray absorber is properly selected depending upon the purpose, it is generally from about 0.5 to 15% by weight as calculated as solids.

(Sensitizer)

For the purposes of improving the acid generation efficiency of the photo acid generating agent and shifting the light-sensitive wavelength into a long wavelength side, a sensitizer may be added in the ink composition of the invention as the need arises. The sensitizer may be any sensitizer so far as it is able to sensitize the photo acid generating agent through an electron transfer mechanism or an energy transfer mechanism. Preferred examples thereof include aromatic polyfused compounds such as anthracene, 9,10-dialkoxy-anthracenes, pyrene, and perylene; aromatic ketone compounds such as acetophenone, benzophenone, thioxanthone, and Michler's ketone; and heterocyclic compounds such as phenothiazine and N-aryloxazolidinones. Though the amount of addition of the sensitizer is properly selected depending upon the purpose, it is generally from 0.01 to 1% by mole, and preferably from 0.1 to 0.5% by mole with respect to the photo acid generating agent.

(Antioxidant)

For the purpose of improving the stability of the ink composition, an antioxidant can be added. Examples of the antioxidant include antioxidants as described in EP-A-223739 (the term “EP-A” as used herein means an “unexamined published European patent application”), EP-A-309401, EP-A-309402, EP-A-310551, EP-A-310552, EP-A-459416, DE-A-3435443 (the term “DE-A” as used herein means an “unexamined published German patent application”), JP-A-54-048535, JP-A-62-262047, JP-A-63-113536, JP-A-63-163351, JP-A-2-262654, JP-A-2-071262, JP-A-3-121449, JP-A-5-061166, JP-A-5-119449, and U.S. Pat. Nos. 4,814,262 and 4,980,275.

Though the amount of addition of the antioxidant is properly selected depending upon the purpose, it is generally from about 0.1 to 8% by weight as calculated as solids.

(Anti-Fading Agent)

In the ink composition of the invention, various organic or metal complex based anti-fading agents can be used. Examples of the organic anti-fading agent include hydroquinones, alkoxyphenols, dialkoxyphenols, phenols, anilines, amines, indanes, chromans, alkoxyanilines, and heterocyclic compounds. Examples of the metal complex based anti-fading agent include nickel complexes and zinc complexes. Concretely, compounds described in patents as cited in Research Disclosure, No. 17643, No. VII, Items I to J, ibid., No. 15162, ibid., No. 18716, page 650, left-hand column, ibid., No. 36544, page 527, ibid., No. 307105, page 872, and ibid., No. 15162; and compounds included in the general formulae of representative compounds and compound examples as describe on pages 127 to 137 of JP-A-62-215272 can be used.

Though the amount of addition of the anti-fading agent is properly selected depending upon the purpose, it is generally from about 0.1 to 8% by weight as calculated as solids.

(Conductive Salt)

For the purpose of controlling injection physical properties, conductive salts such as potassium thiocyanate, lithium nitrate, ammonium thiocyanate, and dimethylamine hydrochloride can be added in the ink composition of the invention.

(Solvent)

In the ink composition of the invention, for the purpose of improving adhesion to the medium to be recorded, it is also effective to add an extremely trace amount of an organic solvent.

Examples of the solvent include ketone based solvents such as acetone, methyl ethyl ketone, and diethyl ketone; alcohol based solvents such as methanol, ethanol, 2-propanol, 1-propanol, 1-butanol, and tert-butanol; chlorine based solvents such as chloroform and methylene chloride; aromatic solvents such as benzene and toluene; ester based solvents such as ethyl acetate, butyl acetate, and isopropyl acetate; ether based solvents such as diethyl ether, tetrahydrofuran, and dioxane; and glycol ether based solvents such as ethylene glycol monomethyl ether and ethylene glycol dimethyl ether.

In this case, it is effective to add the solvent in an amount within the range where problems in solvent resistance and VOC are not caused. Its amount is preferably in the range of from 0.1 to 5% by weight, and more preferably from 0.1 to 3% by weight with respect to the whole of the ink composition.

(High Molecular Compound)

For the purpose of adjusting film physical properties, various high molecular compounds can be added in the ink composition of the invention. Examples of the high molecular compound which can be used include acrylic polymers, polyvinyl butyral resins, polyurethane resins, polyamide resins, polyester resins, epoxy resins, phenol resins, polycarbonate resins, polyvinyl butyral resins, polyvinyl formal resins, shellac, vinyl based resins, acrylic resins, rubber based resins, waxes, and other natural resins. Such a high molecular compound may be used in combination with two or more kinds thereof. Of these, vinyl based copolymers obtainable from copolymerization of an acrylic monomer are preferable. In addition, with respect to the copolymerization composition of a high molecular binding material, copolymers containing, as a structural unit, a “carboxyl group-containing monomer”, an “alkyl methacrylate” or an “alkyl acrylate” are also preferably used.

(Surfactant)

A surfactant may also be added in the ink composition of the invention.

As the surfactant, there are enumerated surfactants as described in JP-A-62-173463 and JP-A-62-183457. Examples thereof include anionic surfactants such as dialkylsulfosuccinic acid salts, alkylnaphthalenesulfonic acid salts, and fatty acid salts; nonionic surfactants such as polyoxyethylene alkyl ethers, polyoxyethylene alkylaryl ethers, acetylene glycols, and polyoxyethylene-polyoxypropylene block copolymers; and cationic surfactants such as alkylamine salts and quaternary ammonium salts. Incidentally, organic fluoro compounds may be used in place of the foregoing surfactants. It is preferable that the organic fluoro compound is hydrophobic. Examples of the organic fluoro compound include fluorine based surfactants, oily fluorine based compounds (for example, fluorine oils), and solid fluorine compound resins (for example, tetrafluoroethylene resins). Also, there are enumerated organic fluoro compounds as described in JP-B-57-009053 (columns 8 to 17) and JP-A-62-135826.

Besides, it is possible to contain, for example, a leveling additive, a matting agent, a wax for adjusting film physical properties, and a tackifier for improving adhesion to a medium to be recorded such as polyolefins and PET, which does not hinder the polymerization, as the need arises.

Concretely, the tackifier includes high molecular adhesive polymers as described on pages 5 to 6 of JP-A-2001-049200 (for example, copolymers made of an ester between (meth)acrylic acid and an alcohol containing an alkyl group having from 1 to 20 carbon atoms, an ester between (meth)acrylic acid and an alicyclic alcohol having from 3 to 14 carbon atoms, or an ester between (meth)acrylic acid and an aromatic alcohol having from 6 to 14 carbon atoms); and low molecular tackiness-imparting resins containing a polymerizable unsaturated bond.

(Preferred Physical Properties of Ink Composition)

Taking into account the injection properties, an ink viscosity of the ink composition of the invention is preferably from 7 to 30 mPa·s, and more preferably from 7 to 20 mPa·s at the temperature at the time of injection. Furthermore, it is preferable that a composition ratio is properly adjusted and determined such that the ink viscosity falls within the foregoing range. Incidentally, the ink viscosity at 25 to 30° C. is from 35 to 500 mPa·s, and preferably from 35 to 200 mPa·s. By setting up the viscosity at room temperature in a high level, even in the case of using a porous medium to be recorded, it is possible to prevent penetration of the ink into the medium to be recorded, to reduce uncured monomers and to reduce odors. In addition, it is possible to control oozing of dots at the time of impacting ink droplets, resulting in an improvement of the image quality. When the ink viscosity at 25 to 30° C. is less than 35 mPa·s, the effect for preventing oozing becomes small. On the other hand, when it exceeds 500 mPa·s, there is caused a problem in delivery of the ink liquid.

A surface tension of the ink composition of the invention is preferably from 20 to 30 mN/m, and more preferably from 23 to 28 mN/m. In the case of achieving recording on various media to be recorded such as polyolefins, PET, coated papers, and non-coated papers, the surface tension of the ink composition of the invention is preferably 20 mN/m or more from the viewpoints of oozing and penetration, and it is preferably not more than 30 mN/m in view of wetting properties.

The thus adjusted ink composition of the invention is suitably used as an ink for ink-jet recording. In the case of using the ink composition of the invention as an ink for ink-jet recording, the ink composition is injected onto a medium to be recorded by an ink-jet printer, and thereafter, the injected ink composition is irradiated with actinic energy ray and cured, thereby achieving recording.

Since a printed matter as obtained from this ink has an image area which has been cured by irradiation with actinic energy ray such as ultraviolet rays and has excellent strength, it can be used for various utilities such as the formation of an ink receiving layer (image area) of a lithographic printing plate other than the formation of an image by the ink.

(Radical Polymerization Based Ink Composition)

The radical polymerization based ink composition contains a radical polymerizable compound and a polymerization initiator. If desired, the radical polymerization based ink composition may further contain a sensitizing dye, a coloring material, and so on.

The respective constitutional components to be used in the radical polymerization based ink composition which can be used will be hereunder described in order.

(Radical Polymerizable Compound)

The radical polymerizable compound includes, for example, a compound containing an addition polymerizable ethylenically unsaturated bond as enumerated below.

(Compound Containing an Addition Polymerizable Ethylenically Unsaturated Bond)

Examples of the compound containing an addition polymerizable ethylenically unsaturated bond which can be used in the ink composition of the invention include esters between an unsaturated carboxylic acid (for example, acrylic acid, methacrylic acid, itaconic acid, crotonic acid, isocrotonic acid, and maleic acid) and an aliphatic polyhydric alcohol compound and amides between the foregoing unsaturated carboxylic acid an aliphatic polyhydric amine compound.

Specific examples of monomers of an ester between an aliphatic polyhydric alcohol compound and an unsaturated carboxylic acid are as follows. That is, examples of acrylic esters include ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and polyester acrylate oligomers.

Examples of methacrylic esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(acryloxyethoxy)phenyl]dimethylmethane. Examples of itaconic esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic esters include ethylene glycol dicrotonate, tetramethylene glycol dicrotonate, pentaerythritol dicrotonate, and sorbitol tetradicrotonate. Examples of isocrotonic esters include ethylene glycol diisocrotonate, pentaerythritol diisocrotonate, and sorbitol tetraisocrotonate. Examples of maleic esters include ethylene glycol dimaleate, triethylene glycol dimaleate, pentaerythritol dimaleate, and sorbitol tetramaleate. In addition, mixtures of the foregoing ester monomers can be enumerated. Also, specific examples of monomers between an aliphatic polyhydric amine compound and an unsaturated carboxylic acid include methylene bisacrylamide, methylene bismethacrylamide, 1,6-hexamethylene bisacrylamide, 1,6-hexamethylene bismethacrylamide, diethylene triamine trisacrylamide, xylylene bisacrylamide, and xylylene bismethacrylamide.

As other examples, there are enumerated vinyl urethane compounds containing two or more polymerizable vinyl groups in one molecule thereof in which a hydroxyl group-containing vinyl monomer represented by the general formula (A): CH₂═C(R)COOCH₂CH(R′)OH (wherein R and R′ each represents H or CH₃) is added to a polyisocyanate compound containing two or more isocyanate groups in one molecule thereof, as described in JP-B-48-041708.

Furthermore, there can be enumerated functional acrylates and methacrylates such as urethane acrylates as described in JP-A-51-037193; polyester acrylates as described in JP-A-48-064183, JP-B-49-043191, and JP-B-52-030490; and epoxy acrylates resulting from a reaction between an epoxy resin and (meth)acrylic acid. In addition, compounds presented as photo curable monomers and oligomers in Journal of the Adhesion Society of Japan, Vol. 20, No. 7, pp. 300-308 (1984) can be used. In the invention, these monomers can be used in a chemical morphology such as prepolymers, namely dimers and trimers, oligomers, and mixtures or copolymers thereof.

The amount of use of the radical polymerizable compound is usually from 1 to 99.99%, preferably from 5 to 90.0%, and more preferably from 10 to 70% (the term “%” means % by weight) with respect to the whole of components of the ink composition.

(Photopolymerization Initiator)

Next, the photopolymerization initiator which is used in the radical polymerization based ink composition of the invention will be hereunder described.

The photopolymerization initiator in the invention is a compound capable of generating a chemical change via an action of light or a mutual action with an electron excited state of a sensitizing dye to form at least one of radicals, acids and bases.

Preferred examples of the photopolymerization initiator include (a) aromatic ketones, (b) aromatic onium salt compounds, (c) organic peroxides, (d) hexaacryl biimidazole compounds, (e) keto oxime ester compounds, (f) borate compounds, (g) azinium compounds, (h) metallocene compounds, (i) active ester compounds, and (j) compounds containing a carbon-halogen bond.

(Sensitizing Dye)

In the invention, for the purpose of improving the sensitivity of the photopolymerization initiator, a sensitizing dye may be added. As the preferred sensitizing dye, there can be enumerated the following compounds which have an absorption wavelength in a region of from 350 nm to 450 nm.

That is, examples of the sensitizing dye include polynuclear aromatic compounds (for example, pyrene, perylene, and triphenylene), xanthenes (for example, Fluororescein, Eosine, Erythrocin, Rhodamine B, and Rose Bengale), cyanines (for example, Thiacarbocyanine and Oxacarbocyanine), merocyanines (for example, merocyanine and carbomerocyanine), thiazines (for example, Thionine, Methylene Blue, and Toluidine Blue), acridines for example Acridine Orange, chloroflavin, and acriflavin), anthraquinones (for example, anthraquinone), squaryliums (for example, squarylium), and coumarins (for example, 7-diethylamino-4-methylcoumarin).

(Cosensitizer)

In addition, known compounds having actions such as an action to further improve the sensitivity and an action to control the polymerization inhibition due to oxygen may be added as a cosensitizer in the ink of the invention.

Examples of such a cosensitizer include compounds as described in M. R. Sander, et al., Journal of Polymer Society, Vol. 10, p. 3173 (1972), JP-B-44-020189, JP-A-51-082102, JP-A-52-134692, JP-A-59-138205, JP-A-60-084305, JP-A-62-018537, JP-A-64-033104, and Research Disclosure, No. 33825. Specific examples thereof include triethanolamine, ethyl p-dimethylaminobenzoate, p-formyldimethylaniline, and p-methylthiodimethylaniline.

As other examples, there are enumerated thiols and sulfides, for example, thiol compounds as described in JP-A-53-000702, JP-B-55-500806, and JP-A-5-142772 and disulfide compounds as described in JP-A-56-075643. Specific examples thereof include 2-methylmercaptobenzothiazole, 2-mercaptobenzoxazole, 2-methylmercaptobenzimidazole, 2-mercapto-4 (3H)-quinazoline, and β-mercaptonaphthalene.

As other examples, there are enumerated amino acid compounds (for example, N-phenylglycine), organometallic compounds as described in JP-B-48-042965 (for example, tributyl tin acetate), hydrogen donators as described in JP-B-55-034414, sulfur compounds as described in JP-A-6-308727 (for example, triathiane), phosphorus compounds as described in JP-A-6-250387 (for example, diethyl phosphite), and Si—H and Ge—H compounds as described in Japanese Patent Application No. 06-191605.

Furthermore, from the viewpoint of enhancing the preservability, it is preferred to add a polymerization inhibitor in an amount of from 200 to 20,000 ppm. It is preferable that the ink for ink-jet recording of the invention is made to have a low viscosity by heating at a temperature in the range of from 40 to 80° C. and then injected. For the purpose of preventing head plugging by thermal polymerization from occurring, it is preferred to add a polymerization inhibitor. Examples of the polymerization inhibitor include hydroquinone, benzoquinone, p-methoxyphenol, TEMPO, TEMPOL, and cupferron Al.

(Others)

Besides, known compounds can be used as the need arises. For example, surfactants, leveling additives, matting agents, and polyester based resins, polyurethane based resins, vinyl based resins, acrylic resins, rubber based resins, and waxes for the purpose of adjusting film physical properties can be properly selected and used. Furthermore, for the purpose of improving adhesion to a medium to be recorded such as polyolefins and PET, it is also preferred to contain a tackifier which does not inhibit the polymerization. Concretely, the tackifier includes high molecular adhesive polymers as described on pages 5 to 6 of JP-A-22001-409200 (for example, copolymers made of an ester between (meth)acrylic acid and an alcohol containing an alkyl group having from 1 to 20 carbon atoms, an ester between (meth)acrylic acid and an alicyclic alcohol having from 3 to 14 carbon atoms, or an ester between (meth)acrylic acid and an aromatic alcohol having from 6 to 14 carbon atoms); and low molecular tackiness-imparting resins containing a polymerizable unsaturated bond.

Furthermore, for the purpose of improving adhesion to the medium to be recorded, it is also effective to add an extremely trace amount of an organic solvent. In this case, it is effective to add the organic solvent in an amount within the range where problems in solvent resistance and VOC are not caused. Its amount is preferably in the range of from 0.1 to 5% by weight, and more preferably from 0.1 to 3% by weight with respect to the whole of the ink composition.

Furthermore, as a measure for preventing a lowering of the sensitivity due to a light shielding effect of the ink coloring material, it is also one of the preferred embodiments to form a radical/cation hybrid type curing ink by combining a cationic polymerizable monomer having a long life as a polymerization initiator and a polymerization initiator.

(Aqueous Ink Composition)

An aqueous ink composition contains a polymerizable compound and a water-soluble photopolymerization initiator capable of generating a radical by the action of actinic energy ray. If desired, the aqueous ink composition may further contain a coloring material and the like.

(Polymerizable Compound)

As the polymerizable compound which is contained in the aqueous ink composition of the invention, polymerizable compounds which are contained in known aqueous ink compositions can be used.

In order to optimize a formulation while taking into account end user characteristics such as curing rate, adhesion and flexibility, a reactive material can be added in the aqueous ink composition. As such a reactive material, for example, (meth)acrylate (namely, acrylate and/or methacrylate) monomers and oligomers, epoxides, and oxetanes are useful.

Examples of the acrylate monomer include phenoxyethyl acrylate, octyldecyl acrylate, tetrahydrofurfuryl acrylate, isobornyl acrylate, hexanediol diacrylate, trimethylolpropane triacrylate, pentaerythritol triacrylate, polyethylene glycol diacrylates (for example, tetraethylene glycol diacrylate), dipropylene glycol diacrylate, tri(propylene glycol) triacrylate, neopentyl glycol diacrylate, bis(pentaerythritol) hexaacrylate, acrylates of an ethoxylated or propoxylated glycol and a polyol (for example, propoxylated neopentyl glycol diacrylate and ethoxylated trimethylolpropane triacrylate), and mixtures thereof.

Examples of the acrylate oligomer include ethoxylated polyethylene glycol, ethoxylated trimethylolpropane acrylate, polyether acrylate and ethoxylated products thereof, and urethane acrylate oligomers.

Examples of the methacrylate include hexanediol dimethacrylate, trimethylolpropane trimethacrylate, triethylene glycol dimethacrylate, diethylene glycol dimethacrylate, ethylene glycol dimethacrylate, 1,4-butanediol dimethacrylate, and mixtures thereof.

The amount of addition of the oligomer is preferably from 1 to 80% by weight, and more preferably from 1 to 10% by weight with respect to the whole weight of the ink composition.

(Water-Soluble Photopolymerization Initiator Capable of Generating a Radical by the Action of Actinic Energy Ray)

The polymerization initiator which can be used in the ink composition of the invention will be hereunder described. As one example, there are enumerated photopolymerization initiators having a wavelength of up to approximately 400 nm. Examples of such a photopolymerization initiator include photopolymerization initiators represented by the following general formulae, which are a substance having functionality in a long wavelength region, namely sensitivity so as to generate a radical by irradiation with ultraviolet rays (hereinafter abbreviated as “TX base”). In the invention, it is especially preferred to properly select and use a compound among these polymerization initiators.

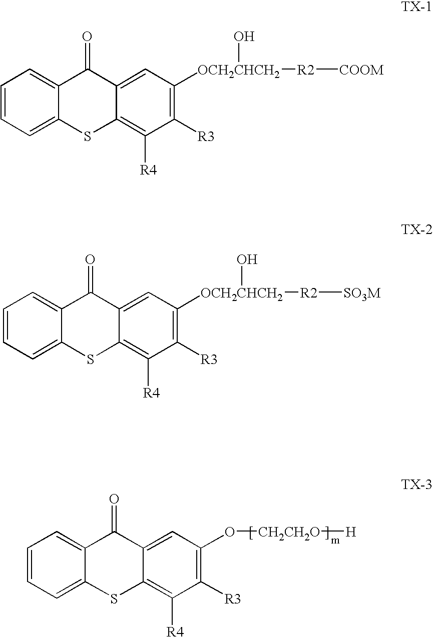

In the foregoing general formulae TX-1 to TX-3, R2 represents —(CH₂)ₓ— (wherein x represents 0 or 1), —O—(CH₂)_{y}— (wherein y represents 1 or 2), or a substituted or unsubstituted phenylene group. Furthermore, when R2 represents a phenylene group, at least one of hydrogen atoms in the benzene ring may be substituted with one or two or more groups or atoms selected from, for example, a carboxyl group or a salt thereof, a sulfonic acid or a salt thereof, a linear or branched alkyl group having from 1 to 4 carbon atoms, a halogen atom (for example, fluorine, chlorine, and bromine), an alkoxyl group having from 1 to 4 carbon atoms, and an aryloxy group such as phenoxy group. M represents a hydrogen atom or an alkali metal (for example, Li, Na, and K). In addition, R3 and R4 each independently represents a hydrogen atom or a substituted or unsubstituted alkyl group. Here, examples of the alkyl group include linear or branched alkyl groups having from approximately 1 to 10 carbon atoms, and especially from approximately 1 to 3 carbon atoms. Furthermore, examples of the substituent of the alkyl group include a halogen atom (for example, a fluorine atom, a chlorine atom, and a bromine atom), a hydroxyl group, and an alkoxyl group (for example, alkoxyl groups having from approximately 1 to 3 carbon atoms). Moreover, m represents an integer of from 1 to 10.

In addition, in the invention, water-soluble derivatives of a photopolymerization initiator, IRGACURE 2959 (a trade name, manufactured by Ciba Specialty Chemicals) represented by the following general formulae can be used. Concretely, a photopolymerization initiator composed of the following formulae IC-1 to IC-3 can be used. 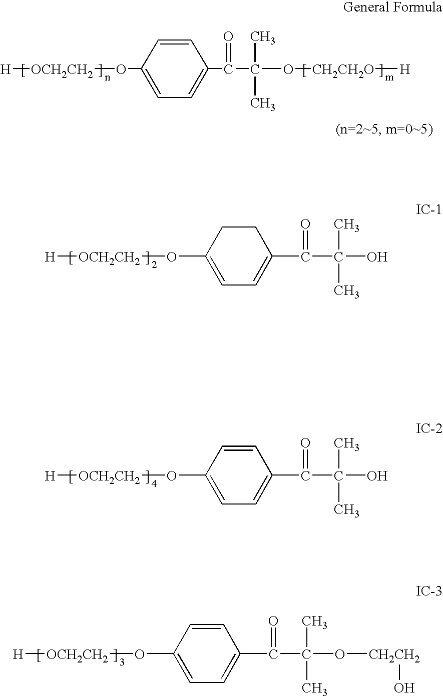
(Formulation for Clear Ink)

By forming the foregoing water-soluble polymerizable compound into a transparent aqueous ink without containing the foregoing coloring material therein, it is possible to prepare clear ink. In particular, by preparing the ink so as to have ink-jet recording characteristics, a water-soluble curing type clear ink for ink-jet recording is obtained. When such an ink is used, since it does not contain a coloring material therein, a clear film can be obtained. Examples of the utilization of the coloring material-free clear ink include use for undercoating for the purpose of imparting adaptability to image printing to a material to be recorded and use for overcoating for the purposes of surface protection of an image as formed by a usual ink and decoration and gloss impartation. In response to these uses, it is also possible to disperse a colorless pigment or a fine particle not for the purpose of coloration, and the like. By adding such substances, it is possible to improve various characteristics such as image quality, fastness and processability (for example, handling properties) of a printed matter.

With respect to the formulation condition in applying such a clear ink, it is preferred to prepare the ink so as to contain from 10 to 85% of the water-soluble polymerizable compound as the major component of the ink and from 1 to 10 parts by weight, based on 100 parts by weight of the water-soluble polymerizable compound, of the photopolymerization initiator (for example, an ultraviolet ray polymerization catalyst), with the photopolymerization initiator being contained in an amount of at least 0.5 parts based on 100 parts of the ink.

(Material Construction in Coloring Material-Containing Ink)

In the case of using the foregoing water-soluble polymerizable compound for a coloring material-containing ink, it is preferred to adjust the concentrations of the polymerization initiator and the polymerizable substance in the ink adaptive to the absorption characteristics of the coloring material which has been contained. As described previously, with respect to the blending amount, the amount of water or the solvent is made to fall within the range of from 40% to 90%, and preferably from 60% to 75% on the weight basis. In addition, the content of the polymerizable compound in the ink is in the range of from 1% to 30%, and preferably from 5% to 20% on the weight basis with respect to the whole amount of the ink. The amount of the polymerization initiator relies upon the content of the polymerizable compound and is generally in the range of from 0.1 to 7%, and preferably from 0.3 to 5% on the weight basis with respect to the whole amount of the ink.

In the case where a pigment is used as the coloring material of the ink, the concentration of the pure pigment fraction in the ink is generally in the range of from 0.3% by weight to 10% by weight with respect to the whole amount of the ink. The coloring power of the pigment relies upon the dispersed state of the pigment particle. The range of from about 0.3% by weight to 1% by weight is the range where the ink is used as an ink of a pale color. When the concentration exceeds this range, a concentration at which the ink is used for general coloration of colors is given.

The present application claims foreign priority based on Japanese Patent Application (JP 2005-151328) filed May 24 of 2005, the contents of which is incorporated herein by reference.

What is claimed is:

1. An ink cartridge storing an ink curable by irradiation with an actinic energy ray, wherein the ink cartridge has a stirring member inside thereof.

2. The ink cartridge according to claim 1, wherein the stirring member is a magnetic rotor.

3. An ink-jet recording device forming an image on a recording medium by jetting an ink, the ink being curable by irradiation with an actinic energy ray, which comprises:
a recording section having an ink-jet head discharging the ink onto the recording medium;
an ink cartridge having a stirring member inside thereof;
a cartridge installing section being freely detachable to the ink cartridge and feeding the ink into the ink-jet head at a time installing the ink cartridge on the cartridge installing section; and
a drive section disposed lateral to the ink cartridge and in a position facing to the stirring member at a time installing the ink cartridge on the cartridge installing section, the drive section being able to activate the stirring member at a timing.

4. The ink-jet recording device according to claim 3, wherein the stirring member is a magnetic rotor, and the drive section comprises a rotary magnet section capable of giving a torque to the magnetic rotor from the outside of the ink cartridge.

5. The ink-jet recording device according to claim 3, wherein the timing activating the stirring member is a time turning on the power-supply into the ink-jet recording device.

6. The ink-jet recording device according to claim 3, wherein the timing activating the stirring member is a time installing the ink cartridge.

7. The ink-jet recording device according to claim 3, wherein the timing activating the stirring member is a time after a lapse of a downtime of the image formation such a degree that precipitation inside of the ink cartridge is actualized.
